(19) United States
(12) Patent Application Publication
(10) Pub. No.: US 2015/0023349 A1
(43) Pub. Date: Jan. 22, 2015

(54) PACKET DISCOVERY AND LEARNING FOR VLAN PROVISIONING

(71) Applicants: Richard Lynn Wheeler, Flemington, NJ (US); Virgil Vladescu, Hillsdale, NJ (US); Stephen Adrian Smith, Van Alstyne, TX (US)

(72) Inventors: Richard Lynn Wheeler, Flemington, NJ (US); Virgil Vladescu, Hillsdale, NJ (US); Stephen Adrian Smith, Van Alstyne, TX (US)

(21) Appl. No.: 13/946,839

(22) Filed: Jul. 19, 2013

(51) Int. Cl. H04L 12/54

(52) U.S. Cl. CPC H04L 12/5689; H04L 2012/5698
USPC 370/392

(57) ABSTRACT

A method and system for performing VLAN provisioning using packet discovery and learning allows a network transport device to support existing VLAN configurations in a new network environment. When Ethernet frames having a VLAN tag are received from a client-side device, an association of the VLAN tag with the client port is recorded at the network transport device. Then, when an Ethernet frame including the VLAN tag is received from a network-side device, the Ethernet frame is directed to the client port associated with the VLAN tag. Additional security measures may restrict a learning period for recording VLAN tag associations. The network transport device may also flood client-side devices and/or network-side devices to associate respective client ports and/or network ports with a VLAN tag.

### BACKGROUND

1. Field of the Disclosure

The present disclosure relates to computer networking and, specifically, to discovery and learning of virtual local area network (VLAN) configurations.

2. Description of the Related Art

As network infrastructure projects are rolled out, provisioning of network equipment and connections to operate in a service provider environment often represents a substantial effort involving both time and operational resources. The service provider environment may be associated with certain network features and/or topology that needs to be implemented on the new infrastructure during provisioning. For example, an existing VLAN configuration may need to be realized on new network components, as they become available for installation.

However, a new rollout project for network infrastructure may involve time constraints that do not allow for the design and development of new and/or updated provisioning software and associated tools/functionality. For example, provisioning a VLAN on a new generation of network components and keeping track of VLAN settings of individual network devices may involve a significant effort for a network service provider operating a large national network system and having a need for a uniform solution. Network service providers may accordingly have a need for methods of provisioning VLANs on network devices that enables rapid installation and deployment of network infrastructure.

### SUMMARY

In one aspect, a disclosed method for discovering virtual local area network (VLAN) associations at a network transport device includes receiving a first Ethernet frame from a first client-side device at a first client port included with the network transport device, the first Ethernet frame including a VLAN tag, and recording an association of the VLAN tag with the first client port. The method may include receiving a second Ethernet frame from a network-side device at a network port included in the network transport device, the second Ethernet frame including the VLAN tag. Based on the association of the VLAN tag with the first client port, the method may include directing the second Ethernet frame to the first client port.

Additional disclosed aspects for discovering virtual local area network (VLAN) associations at a network transport device include a system comprising the network transport device and the network transport device comprising a processor, a plurality of client ports, including a first client port, a network port, and a memory accessible to the processor storing processor-executable instructions.

### BRIEF DESCRIPTION OF THE DRAWINGS

FIG. 1 is a block diagram of selected elements of an embodiment of a network transport device;

FIG. 2 is a block diagram of selected elements of an embodiment of a cellular network;

FIG. 3 is a flowchart depicting selected elements of an embodiment of a method for packet discovery and learning of a VLAN configuration;

FIG. 4 is a flowchart depicting selected elements of an embodiment of a method for packet discovery and learning of a VLAN configuration; and

FIG. 5 is a flowchart depicting selected elements of an embodiment of a method for packet discovery and learning of a VLAN configuration.

### DESCRIPTION OF PARTICULAR EMBODIMENT(S)

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

As network infrastructure is renewed, the provisioning capabilities of a network service provider may lag behind actual purchasing, installation, and deployment of the physical network components and systems. For example, in the cellular telephone network industry, as new generations of cellular sites are installed, the corresponding connections to network switching devices may depend upon proper VLAN configurations for proper operation. Since each new generation of cellular technology involves a much larger scale network than the previous generation, the demands on operations, service, and support (OSS) capabilities of the network service provider may also increase dramatically. Specifically, a cellular network service provider may not be able to design and develop a customized OSS solution for provisioning VLANs on new network nodes fast enough to keep up with the actual rollout of the physical network infrastructure.

As will be described in detail herein, the inventors of the present disclosure have discovered a novel solution for VLAN provisioning that can automatically detect, without additional input or manual effort, VLAN tags included in Ethernet packets received at a network transport device. The network transport device may then record associations of VLAN tags to individual ports, thereby provisioning the VLAN using a packet discovery and learning method. In this manner, the methods and systems described herein may enable rapid installation and rollout of network infrastructure, without being dependent on a centralized and/or standardized provisioning tool for proper operation of desired network configurations, such as VLANs.

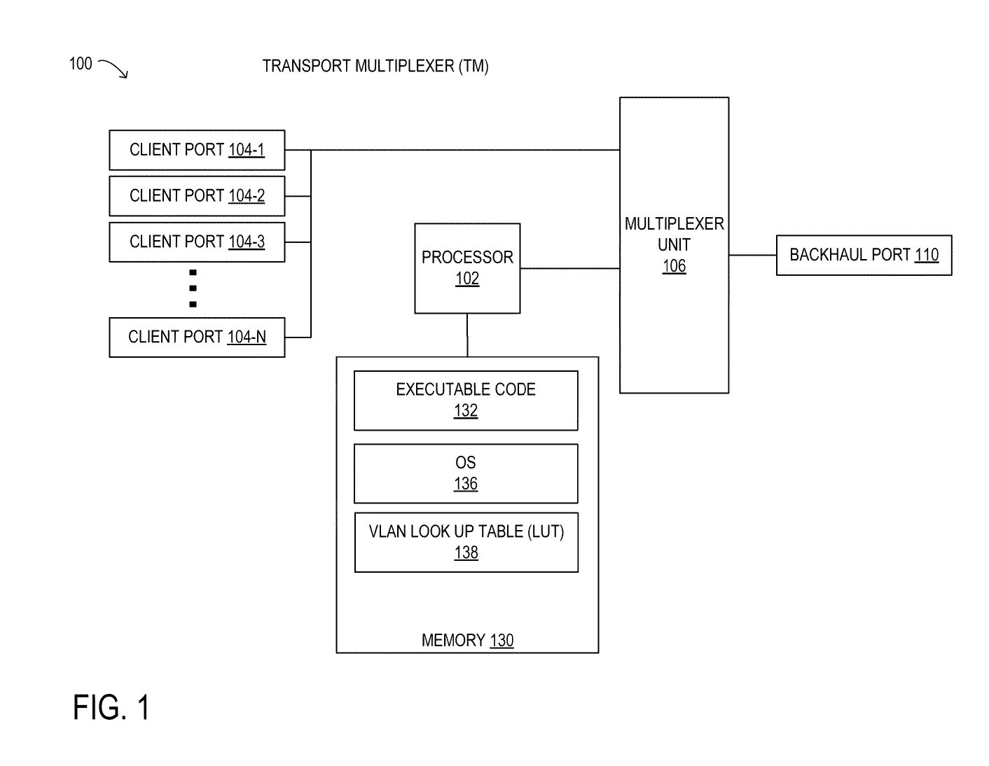

Turning now to the drawings, FIG. 1 is a block diagram showing selected elements of an embodiment of transport multiplexer (TM) 100, representing a “network transport device”, as referred to herein. In particular embodiments, TM 100 represents a physical layer device (i.e., layer 2 or L2) as defined by IEEE 802. In various embodiments, TM 100 may represent different particular types of devices, such as an L2 multiplexer, an optical transport network/L2 multiplexer, and/or a Synchronous Optical Networking (SONET)/L2 multiplexer. In some embodiments, TM 100 may represent a data link layer (i.e., layer 1 or L1) device that includes an L2 element.

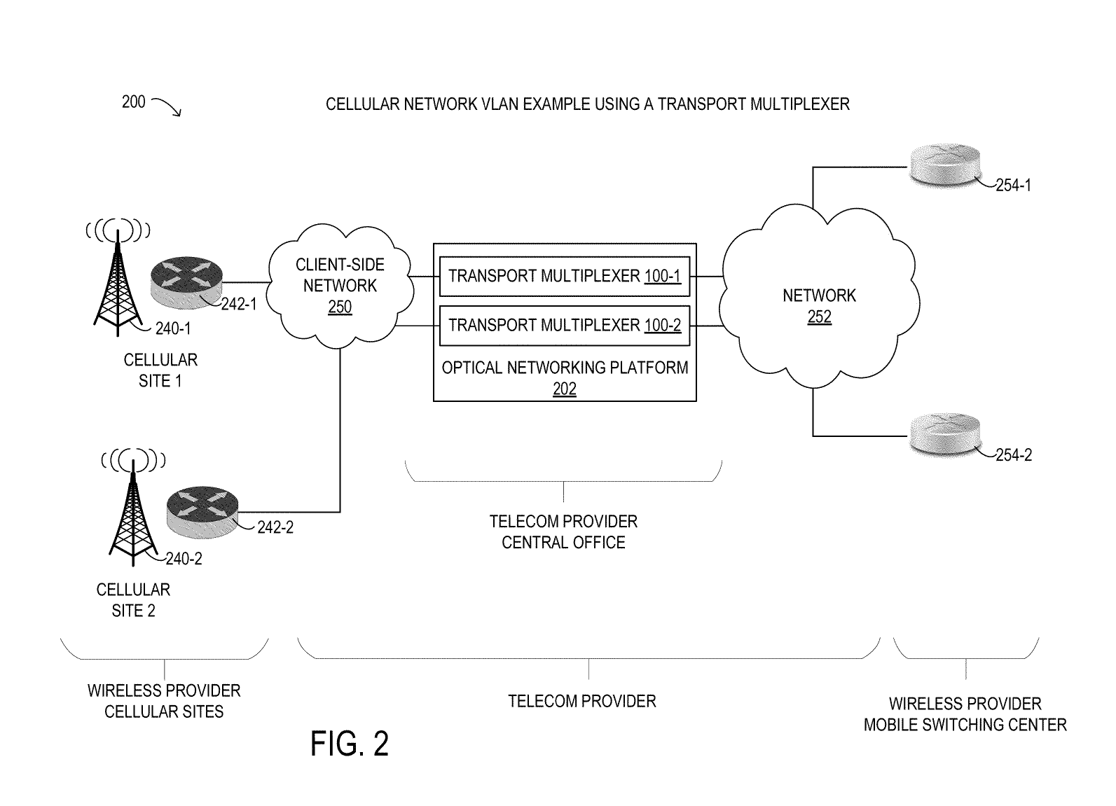

As will be described in further detail, TM 100 may be able to learn VLAN configuration information from received network packets that include VLAN tags and may accordingly provision at least a portion of a VLAN based on the learned VLAN configuration information. One example of how VLAN tagging of Ethernet packets is performed is specified by the IEEE 802.1Q standard, with which TM 100 may comply. It is noted that TM 100 may more generally comply with at least a portion of IEEE 802 standards describing how networks and network components handle and process Ethernet packets of variable-size. As shown in FIG. 1, TM 100 includes client ports 104, multiplexer unit 106, network port 110, processor 102, and memory 130. Although processor 102 and memory 130 are shown in FIG. 1 with one instance of multiplexer unit 106 for descriptive clarity, it will be understood that processor 102 may be implemented to support more than one instance of multiplexer 106 in various embodiments (not shown in FIG. 1, see also FIG. 2).

As shown in FIG. 1, processor 102 communicatively couples to multiplexer unit 106 and memory 130 and may control the operation and administration of TM 100 by processing information received from client ports 104, network port 110, and/or memory 130. Processor 102 includes any hardware and/or software that operates to control and process information. Processor 102 may be a programmable logic device, a microcontroller, a microprocessor, a field-programmable gate array (FPGA), an application-specific integrated circuit (ASIC), another suitable processing device, and/or a suitable combination of the preceding.

In FIG. 1, memory 130 stores, either permanently or temporarily, data, operational software, executable instructions, and/or other information for processor 102, and/or other components of TM 100. Memory 130 may include volatile, non-volatile, local and/or remote devices suitable for storing information. For example, memory 130 may include random access memory (RAM), read only memory (ROM), flash memory, magnetic storage devices, optical storage devices, network storage devices, cloud storage devices, and/or other suitable information storage devices. As shown, memory 130 stores executable code 132, operating system (OS) 136, and VLAN look up table (LUT) 138. Executable code 132 may represent instructions executable by processor 102, including programs and routines suitable for execution by OS 136, which may represent a UNIX or UNIX-like operating system, a Windows® family operating system, an embedded operating system, and/or another suitable operating system, and/or various components thereof. VLAN LUT 138 may represent a record of associations of VLAN tags to individual ones of client ports 104, as will be described herein.

In operation, TM 100 may be installed on a network by connecting network port 110 to a network-side device (not shown in FIG. 1, see also FIG. 2), while client port 104-1, 104-2, 104-3, and further up to client port 104-N when present, may be connected to respective client-side devices (not shown in FIG. 1, see also FIG. 2). In various embodiments, network port 110 may be connected to a so-called “trunk” network connection, such as a 10 gigabyte Ethernet (GE) connection, while client ports 104 may be connected to lower capacity network connections, such as a 1 GE connection. It is noted that other types of network connections may be supported by client ports 104 and/or network port 110 in different embodiments.

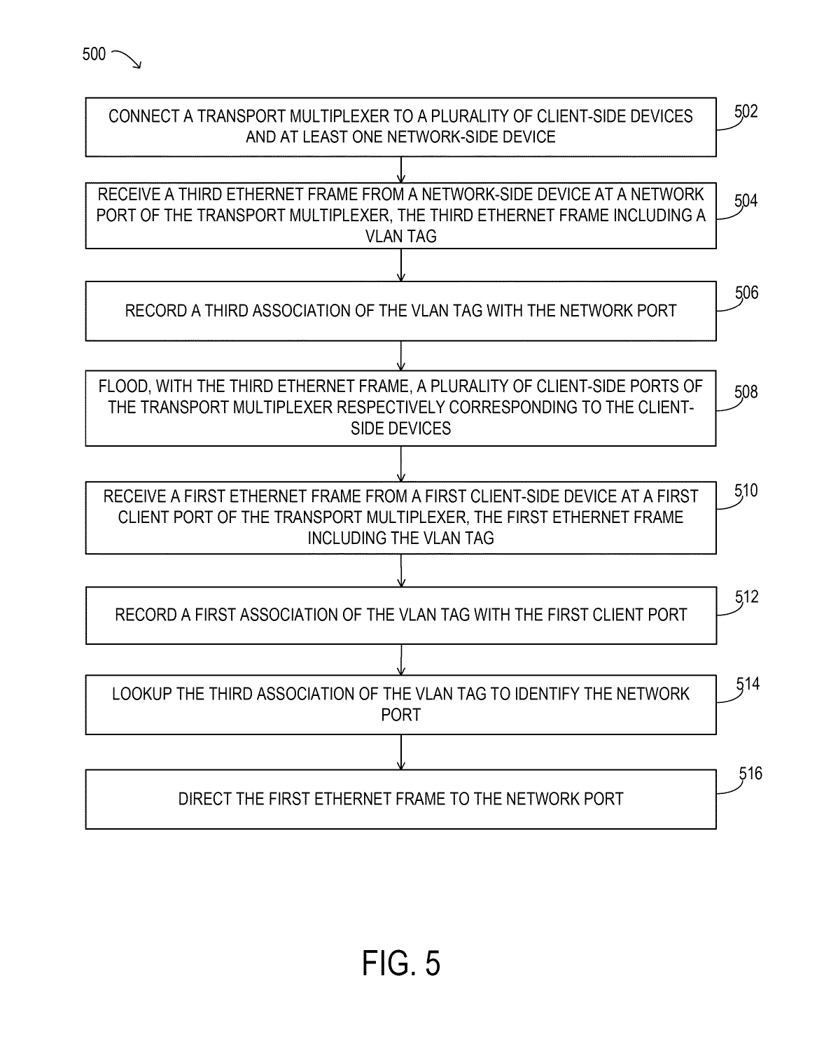

Once installed in an operational network environment, TM 100 in FIG. 1 may begin to receive network traffic in the form of Ethernet packets (or frames). For example, client-side devices may begin to send Ethernet packets (not shown) via individual ones of client ports 104 to which they are coupled to TM 100. When the client-side device has been provisioned to be a part of a VLAN, the Ethernet packets received at client port 104 may include a VLAN tag. The VLAN tag may be unique to the network-side device. Upon receipt of the Ethernet packet including the VLAN tag at client port 104, processor 102 may record an association of the VLAN tag to client port 104. The association may be recorded in VLAN LUT 138 that is accessible to processor 102. Then, when a second Ethernet packet containing a VLAN tag is received at network port 110, processor 102 may look-up a value (or the entire contents) included with the received VLAN tag in VLAN LUT 138. When a match is found in VLAN LUT 138, processor 102 may determine which client port 104 to direct the second Ethernet packet based on the association recorded in VLAN LUT 138. When no match is found in VLAN LUT 138 for a VLAN tag received at network port 110, in certain embodiments, processor 102 may decide to flood all client ports 104 with the Ethernet frame containing the VLAN tag (see also FIG. 5). As more VLAN tags are received from client ports 104, TM 100 may effectively self-provision at least one VLAN between network port 110 and client ports 104 without external input or commands. In this manner, many instances of TM 100 may be used across a larger network and may immediately begin operating properly with desired VLAN configurations and also may operate in a uniform manner. It is noted that VLAN LUT 138 may be queried from TM 100 to obtain specific VLAN configuration information with respect to client ports 104.

Furthermore, additional security aspects may be applied to the packet discovery and learning method of VLAN provisioning implemented by TM 100 in FIG. 1. For example, a given entry in VLAN LUT 138 may only be valid for a given time period (i.e., age), after which, the entry may be deleted by processor 102. In another example, TM 100 may be selectively operated in a so-called “learning mode”, during which the packet discovery and learning method is performed. When TM 100 is not operated in learning mode, no further entries in VLAN LUT 138 may be recorded, while existing entries may still be used for the purpose of directing Ethernet packets, as described above. Certain conditions may be applied to restrict when learning mode is available on TM 100. In particular embodiments, the learning mode may be activated for a certain period in response to powering on, or upon command. In some embodiments, the learning mode may be active during a reset period that is started in response to receiving a command at TM 100, for example, by a network administrator. In various embodiments, the learning mode may be active during a provisioning period that is initiated when client port 104 is provisioned, activated, and/or connected. When the period for discovery and learning begins, processor 102 may delete at least certain portions of the previous contents of VLAN LUT 138, as desired, so that a forced update of at least certain portions of VLAN LUT 138 is performed according to the procedures described herein.

Referring now to FIG. 2, a block diagram of selected elements of an embodiment of cellular network 200 is depicted. As shown, cellular network 200 depicts certain portions of an exemplary environment in which TM 100 (see also FIG. 1) may be used to perform packet discovery and learning of a VLAN configuration, as described herein. Although the example network shown in FIG. 2 is a cellular network, it is noted that packet discovery and learning of a VLAN configuration, as described herein, may be performed using various types of networks where TM 100 may be used (see also FIG. 1).

In FIG. 2, a wireless provider (not shown) may operate a cellular network and may desire to install cellular sites 240 at desired locations and to connect respective pluralities of cellular sites 240 to respective mobile switching centers 254. In the network architecture depicted in FIG. 2, optical networking platform 202 may serve to provide packet aggregation functionality at the transport level between network 252 and client-side network 250. Specifically, optical networking platform 202 may be a reconfigurable chassis that receives various sub-components, such as, but not limited to, TM 100 (see also FIG. 1). In one example, optical networking platform 202 represents a device in the FUJITSU FLASHWAVE® family of optical networking platforms. As shown in FIG. 2, the wireless provider may own and operate mobile switching centers 254 as well as cellular sites 240, including routers 242, while a telecom provider (not shown) different from the wireless provider, may own and/or operate client-side network(s) 250 and network 252, for example, on behalf of the wireless provider. The telecom provider may accordingly install and operate multiple instances of optical networking platform 202 at a central office (CO) to aggregate connections between client-side network 250 and network 252. In other embodiments (not shown), a single entity may operate cellular network 200.

As shown in FIG. 2, optical networking platform 202 is equipped to receive two instances of TM 100, namely 100-1 and 100-2, which are respectively connected to mobile switching centers 254-1 and 254-2 via network 252. Network 252 may be a switchable optical network, such as a wavelength division multiplexing (WDM) optical transport network (OTN) using reconfigurable optical add-drop multiplexers (ROADMs) for routing traffic from desired sources to desired destinations. Mobile switching centers 254 may represent data processing facilities for handling larger volumes of cellular connections, such as a regional node in cellular network 200. Accordingly, network 252 may extend over larger service areas to connect a plurality of regions and/or regional nodes (not shown).

On the client side in FIG. 2, TM 100-1 may be connected to both routers 242-1 and 242-2 via client-side network, respectively serving cellular site 1 and cellular site 2, at individual client ports. TM 100-2 may concurrently provide aggregation and transport services to another plurality of cellular sites (not shown). Client-side network 250 may be an optical transport network (OTN), that implements protocols such as SONET, Synchronous Data Hierarchy (SDH), and/or Native Ethernet and may employ wavelength division multiplexing (WDM) to enable transmission of multiple carrier signals at different optical wavelengths. Although shown as a single entity for descriptive clarity in FIG. 2, it is noted that client-side network 250 may be comprised of smaller network segments covering a certain geographical area serviced by a corresponding plurality of cellular sites 240. In operation, cellular network 200 may configure VLANs by performing packet discovery and learning of a VLAN configuration using TMs 100-1, 100-2, as described previously with respect to FIG. 1. In particular, the packet discovery and learning of the VLAN configuration may be performed when cellular sites 240/routers 242 are installed and/or reconfigured with new network components, such as during a rollout of a new generation of wireless technology.

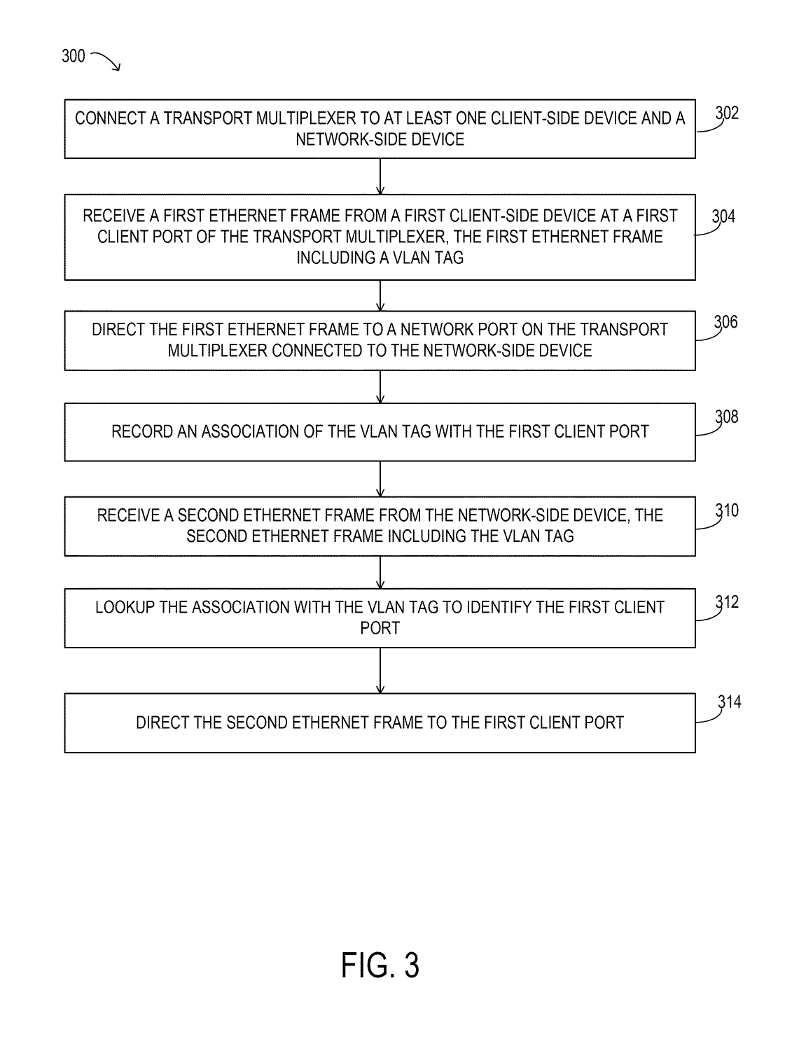

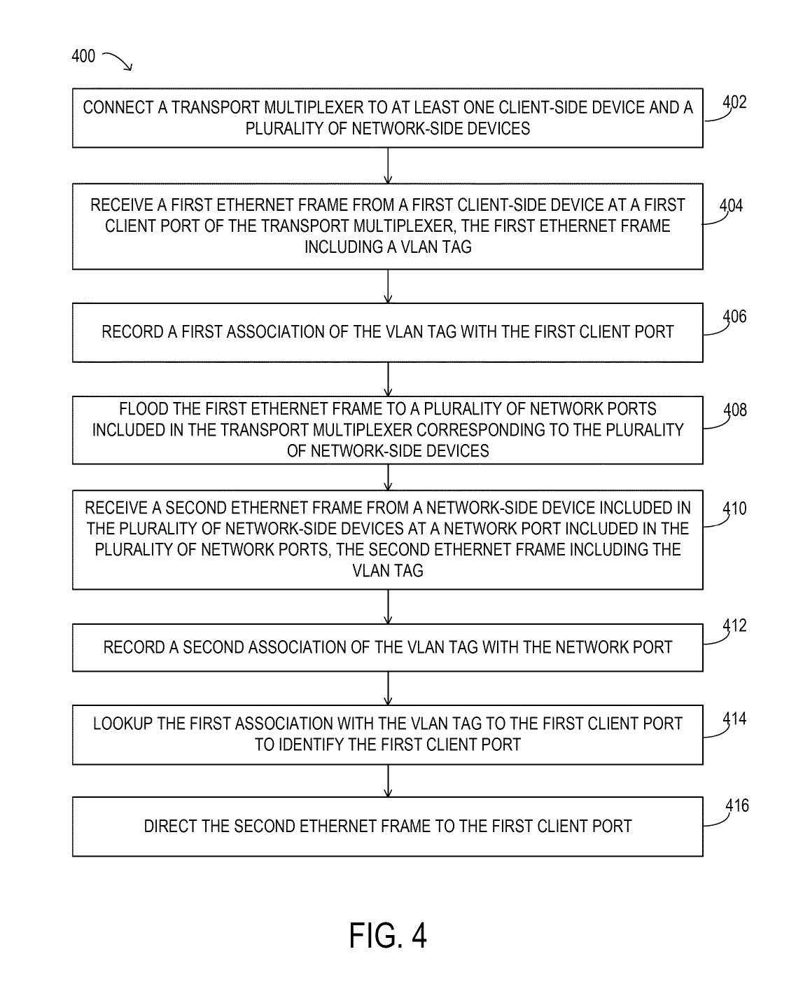

Turning now to FIG. 3, a block diagram of selected elements of an embodiment of method 300 for performing packet discovery and learning of a VLAN configuration is shown in flow chart format. It is noted that certain operations depicted in method 300 may be rearranged or omitted, as desired. In various embodiments, at least certain portions of method 300 may be used in conjunction with methods 400 and 500 (see FIGS. 4 and 5).

Method 300 may begin by connecting (operation 302) a transport multiplexer (TM) to at least one client-side device and a network-side device. A first Ethernet frame may be received (operation 304) from a first client-side device at a first client port of the TM, the first Ethernet frame including a VLAN tag. The first client-side device is connected to the first client port of the TM. The first Ethernet frame may be directed (operation 306) to a network port on the TM connected to the network-side device. An association of the VLAN tag with the first client port may be recorded (operation 308). The association may be recorded in a look-up table. Then, a second Ethernet frame may be received (operation 310) from the network-side device, the second Ethernet frame including the VLAN tag. The association with the VLAN tag may be looked up (operation 312) to identify the first client port. Finally, the second Ethernet frame may be directed (operation 314) to the first client port.

Turning now to FIG. 4, a block diagram of selected elements of an embodiment of method 400 for performing packet discovery and learning of a VLAN configuration is shown in flow chart format. Method 400 is directed to embodiments in which the TM is connected to, or has access to, more than one network-side device and when the TM is unaware which network port corresponding to a particular network side device is associated with a VLAN tag received from a client-side device, and performs a network-side flooding to recognize a network-side device associated with the VLAN tag. It is noted that certain operations depicted in method 400 may be rearranged or omitted, as desired. In various embodiments, at least certain portions of method 400 may be used in conjunction with methods 300 and 500 (see FIGS. 3 and 5).

Method 400 may begin by connecting (operation 402) a transport multiplexer (TM) to at least one client-side device and a plurality of network-side devices. A first Ethernet frame may be received (operation 404) from a first client-side device at a first client port of the TM, the first Ethernet frame including a VLAN tag. The first client-side device is connected to the first client port of the TM. A first association of the VLAN tag with the first client port may be recorded (operation 406). The first association may be recorded in a look-up table. The first Ethernet frame may then be flooded (operation 408) to a plurality of network ports included in the TM corresponding to the plurality of network-side devices. It is noted that the plurality of network ports may represent a provisioned set of network ports selected from a larger plurality of network ports included in the TM. Then, a second Ethernet frame may be received (operation 410) from a network-side device included in the plurality of network-side devices, the second Ethernet frame including the VLAN tag. A second association of the VLAN tag with the network port may be recorded (operation 412). The second association may be recorded in a look-up table. The first association with the VLAN tag may be looked up (operation 414) to identify the first client port. Finally, the second Ethernet frame may be directed (operation 416) to the first client port.

Turning now to FIG. 5, a block diagram of selected elements of an embodiment of method 500 for performing packet discovery and learning of a VLAN configuration is shown in flow chart format. Method 500 is directed to embodiments in which the TM receives an Ethernet frame including a VLAN tag prior to recording the association of the VLAN tag to a particular client port and performs a client-side flooding to recognize a client-side device associated with the VLAN tag. It is noted that certain operations depicted in method 500 may be rearranged or omitted, as desired. In various embodiments, at least certain portions of method 500 may be used in conjunction with methods 300 and 400 (see FIGS. 3 and 4).

Method 500 may begin by connecting (operation 502) a transport multiplexer (TM) to at least one client-side device and at least one network-side device. A third Ethernet frame may be received (operation 504) from a network port of the TM, the third Ethernet frame including a VLAN tag. It is noted that the third Ethernet frame may represent an initial Ethernet frame received by the TM in method 500, and is so designated to maintain consistency with terminology used in methods 300 and 400 (see FIGS. 3 and 4). A third association of the VLAN tag with the network port may be recorded (operation 506). The third association may represent an initial association and is also so designated to maintain consistency with terminology used on methods 300 and 400. The third association may be recorded in a look-up table. A plurality of client-side ports of the TM respectively corresponding to the client-side devices may be flooded (operation 508) with the third Ethernet frame. A first Ethernet frame may be received (operation 510) from a first client-side device at a first client port of the TM, the first Ethernet frame including the VLAN tag. The first client-side device is connected to the first client port of the TM. It is noted that, in method 500, the first Ethernet frame is received after the third Ethernet frame. A first association of the VLAN tag with the first client port may be recorded (operation 512). The first association may be recorded in a look-up table. The third association of the VLAN tag may be looked up (operation 514) to identify the network port. Finally, the first Ethernet frame may be directed (operation 516) to the network port.

As disclosed herein, a method and system for performing VLAN provisioning using packet discovery and learning allows a network transport device to support existing VLAN configurations in a new network environment. When Ethernet frames having a VLAN tag are received from a client-side device, an association of the VLAN tag with the client port is recorded at the network transport device. Then, when an Ethernet frame including the VLAN tag is received from a network-side device, the Ethernet frame is directed to the client port associated with the VLAN tag. Additional security measures may restrict a learning period for recording VLAN tag associations. The network transport device may also flood client-side devices and/or network-side devices to associate respective client ports and/or network ports with a VLAN tag.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for discovering virtual local area network (VLAN) associations at a network transport device, comprising:
receiving a first Ethernet frame from a first client-side device at a first client port included with the network transport device, the first Ethernet frame including a VLAN tag;
recording a first association of the VLAN tag with the first client port;
receiving a second Ethernet frame from a network-side device at a network port included in the network transport device, the second Ethernet frame including the VLAN tag; and
based on the first association of the VLAN tag with the first client port, directing the second Ethernet frame to the first client port.

2. The method of claim 1, wherein the network transport device is accessible to a plurality of network ports, including the network port, and further comprising:
prior to receiving the second Ethernet frame from the network side-device, flooding the first Ethernet frame to the plurality of network ports; and
after receiving the second Ethernet frame, recording a second association of the VLAN tag with the network port, wherein the second Ethernet frame is received in response to flooding the first Ethernet frame to the plurality of network ports.

3. The method of claim 1, further comprising:
prior to receiving the first Ethernet frame:
receiving a third Ethernet frame from the network-side device at the network port, the third Ethernet frame including the VLAN tag;
after receiving the third Ethernet frame, recording a third association of the VLAN tag with the network port; and
flooding, with the third Ethernet frame, a plurality of client-side ports included in the network transport device, including the first client port, wherein the first Ethernet frame is received in response to flooding the plurality of client-side ports with the third Ethernet frame; and
after receiving the first Ethernet frame, based on the third association of the VLAN tag with the network port, directing the first Ethernet frame to the network port.

4. The method of claim 1, wherein recording the first association of the VLAN tag with the first client port is performed during a learning period having a defined duration, the learning period selected from:
an initial period in response to powering on the network transport device;
a reset period initiated in response to receiving a command at the network transport device; and
a provisioning period initiated in response to provisioning a client port included with the network transport device.

5. The method of claim 4, further comprising:
when the learning period begins, deleting previously recorded associations of VLAN tags to client ports.

6. The method of claim 1, wherein the first Ethernet frame is received when the network transport device is installed on a network, wherein the network-side device is connected to the network port, and wherein the first client-side device is connected to the first client port.

7. The method of claim 6, wherein the network port is a 10 gigabit Ethernet port, and wherein the first client port is a 1 gigabit Ethernet port, and further comprising:
directing the first Ethernet frame to the network port.

8. The method of claim 1, wherein the first client-side device is a cellular site router and wherein the network-side device is a mobile switching center.

9. The method of claim 1, further comprising:
determining an age of the first association of the VLAN tag with the first client port; and
when the age exceeds a predetermined time value, deleting the first association.

10. A system for discovering virtual local area network (VLAN) associations, comprising:
a network-side device for switching to a plurality of network transport devices including a first network transport device;
a plurality of client-side devices, including a first client-side device, coupled to the first network transport device; and
the first network transport device, further comprising:
a processor;
a plurality of client ports, including a first client port;
a network port; and
a memory accessible to the processor storing processor-executable instructions that, when executed, cause the processor to:
receive a first Ethernet frame from the first client-side device at the first client port, the first Ethernet frame including a VLAN tag;
record a first association of the VLAN tag with the first client port;
receive a second Ethernet frame from a network-side device at the network port, the second Ethernet frame including the VLAN tag; and
based on the first association of the VLAN tag with the first client port, direct the second Ethernet frame to the first client port.

11. The system of claim 10, wherein the first network transport device is accessible to a plurality of network ports, including the network port, and further comprising instructions to cause the processor to:
prior to receiving the second Ethernet frame from the network side-device, flood the first Ethernet frame to the plurality of network ports; and
after receiving the second Ethernet frame, record a second association of the VLAN tag with the network port, wherein the second Ethernet frame is received in response to executing the instructions to flood the first Ethernet frame to the plurality of network ports.

12. The system of claim 10, further comprising instructions to cause the processor to:
prior to receiving the first Ethernet frame:
receive a third Ethernet frame from the network-side device at the network port, the third Ethernet frame including the VLAN tag;
after receiving the third Ethernet frame, record a third association of the VLAN tag with the network port; and
flood, with the third Ethernet frame, a plurality of client-side ports included in the network transport device, including the first client port, wherein the first Ethernet frame is received in response to flooding the plurality of client-side ports with the third Ethernet frame; and
after receiving the first Ethernet frame, based on the third association of the VLAN tag with the network port, direct the first Ethernet frame to the network port.

13. The system of claim 10, wherein the instructions to cause the processor to record the first association of the VLAN tag with the first client port are executed during a learning period having a defined duration, the learning period selected from:
an initial period in response to powering on the network transport device;
a reset period initiated in response to receiving a command at the first network transport device; and
a provisioning period initiated in response to provisioning a client port included with the first network transport device.

14. The system of claim 13, further comprising instructions to cause the processor to:
when the learning period begins, delete previously recorded associations of VLAN tags to client ports.

15. The system of claim 10, wherein the network port is a 10 gigabit Ethernet port, and wherein the first client port is a 1 gigabit Ethernet port, and further comprising instructions to cause the processor to:
direct the first Ethernet frame to the network port.

16. The system of claim 10, wherein the plurality of client-side devices are cellular site routers, and wherein the network-side device is a mobile switching center.

17. The system of claim 10, further comprising instructions to cause the processor to:
determine an age of the first association of the VLAN tag with the first client port; and
when the age exceeds a predetermined time value, delete the first association.

18. A network transport device, comprising:
a processor;
a plurality of client ports, including a first client port;
a network port; and
a memory accessible to the processor storing processor-executable instructions that, when executed, cause the processor to:
receive a first Ethernet frame from the first client-side device at the first client port, the first Ethernet frame including a VLAN tag;
record a first association of the VLAN tag with the first client port;
receive a second Ethernet frame from a network-side device at the network port, the second Ethernet frame including the VLAN tag; and
based on the first association of the VLAN tag with the first client port, direct the second Ethernet frame to the first client port.

19. The network transport device of claim 18, wherein the network transport device is accessible to a plurality of network ports, including the network port, and further comprising instructions to cause the processor to:
prior to receiving the second Ethernet frame from the network side-device, flood the first Ethernet frame to the plurality of network ports; and
after receiving the second Ethernet frame, record a second association of the VLAN tag with the network port, wherein the second Ethernet frame is received in response to executing the instructions to flood the first Ethernet frame to the plurality of network ports.

20. The network transport device of claim 18, further comprising instructions to cause the processor to:
prior to receiving the first Ethernet frame:
receive a third Ethernet frame from the network-side device at the network port, the third Ethernet frame including the VLAN tag;
after receiving the third Ethernet frame, record a third association of the VLAN tag with the network port; and
flood, with the third Ethernet frame, a plurality of client-side ports included in the network transport device, including the first client port, wherein the first Ethernet frame is received in response to flooding the plurality of client-side ports with the third Ethernet frame; and
after receiving the first Ethernet frame, based on the third association of the VLAN tag with the network port, direct the first Ethernet frame to the network port.

21. The network transport device of claim 18, wherein the instructions to cause the processor to record the first association of the VLAN tag with the first client port are executed during a learning period having a defined duration, the learning period selected from:
an initial period in response to powering on the network transport device;
a reset period initiated in response to receiving a command at the first network transport device; and
a provisioning period initiated in response to provisioning a client port included with the first network transport device.

22. The network transport device of claim 21, further comprising instructions to cause the processor to:
when the learning period begins, delete previously recorded associations of VLAN tags to client ports.

23. The network transport device of claim 18, wherein the network port is a 10 gigabit Ethernet port, and wherein the first client port is a 1 gigabit Ethernet port, and further comprising instructions to cause the processor to:
direct the first Ethernet frame to the network port.

24. The network transport device of claim 18, wherein the instructions are executed when the network transport device is installed on a network, wherein the network-side device is connected to the network port, and wherein a plurality of client-side devices are connected to the plurality of client ports.

25. The network transport device of claim 18, wherein the plurality of client-side devices are cellular site routers, and wherein the network-side device is a mobile switching center.

26. The network transport device of claim 18, further comprising instructions to cause the processor to:
determine an age of the first association of the VLAN tag with the first client port; and
when the age exceeds a predetermined time value, delete the first association.
